(19) United States
(12) Patent Application Publication
(10) Pub. No.: US 2003/0115177 A1
(43) Pub. Date: Jun. 19, 2003

(54) Process failure information management system

(75) Inventors: Naoko Takanabe, Tokyo (JP); Saori Kakei, Itami-shi (JP); Masakazu Nakabayashi, Tokyo (JP); Masahiko Morishita, Tokyo (JP); Akira Hamasaki, Itami-shi (JP); Shoko Kanazawa, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/170,565

(22) Filed: Jun. 14, 2002

(30) Foreign Application Priority Data
Dec. 17, 2001 (JP) 2001-382890

(51) Int. Cl. G06F 7/00

(52) U.S. Cl. 707/1

(57) ABSTRACT

A process failure information management system including a server and a terminal, in which an user inputs information concerning a process failure using the terminal and the input information are stored into a database of the server. The date of input by the user is stored into the database. When a prescribed period has passed from the date of input stored in the database without input by an user of the following step, the server sends an E-mail for asking for an input of information to the user who inputs information at the following step.

### BACKGROUND OF THE INVENTION

The present invention relates to a process failure information management system for supporting and managing a serial business including the analysis of causes, the draft of measures, the execution of the measures and the confirmation of the effects for a process failure caused in a manufacturing process, and for managing and storing the serial business as a report to be retrieval and readable.

Industrial products are usually manufactured through a plurality of processes. In the manufacture of a semiconductor product, for example, there are various processes including a process of forming a thin film on a silicon wafer, a process of forming a mask on the thin film by using photolithography, and a process of removing, by etching, a portion of the thin film which is not covered with the mask. The total number of processes to be carried out until the product is finished is, for example, approximately 300 to 500.

In any of these processes, if a process failure is caused, for example, a processing temperature is too high, a processing time is too long or the product is fallen by mistake, quality required for the finished product might not be obtained. Accordingly, a partially manufactured product (which has not been finished as a product and is therefore referred to as a partially manufactured product) subjected to the process failure is discarded without transfer to succeeding processes. Alternatively, in the case where the degree of the process failure is low and necessary quality can be maintained, the product is set to be a partially manufactured product which requires care and is transferred to a subsequent process.

In the case where the partially manufactured product is discarded, it is a matter of course that yield is reduced so that a manufacturing cost is increased. On the other hand, in the case where the product is transferred as a partially manufactured product requiring care to subsequent processes, works and management at the subsequent processes are to be specially careful so that a working efficiency is reduced and the cost of the management is increased, thereby the manufacturing cost is increased. Accordingly, it is important that the occurrence of the process failure should be decreased as much as possible in order to maintain the quality of the product and to reduce the manufacturing cost thereof.

In the case where the process failure is caused, first of all, the actual conditions are examined to decide treatment (e.g. discard or special care) for the partially manufactured product in the lot, and furthermore, the cause of the process failure is investigated, the measures are examined, and the measures are executed and the effects of the measures are confirmed. By such a series of works, the same kind of process failure can be prevented from being caused again.

In an actual manufacturing factory, a series of works for examining the actual conditions of the process failure and preventing the recurrence of the process failure are often carried out by another division or manager. For example, the actual conditions are examined by the quality control staff of a manufacturing department, the causes are examined by the technical staff of the manufacturing department, the measures are investigated by an engineer of a technical department, the measures are executed by the technical staff of the manufacturing department, and the quality control staff of the manufacturing department confirm the effects.

In such a case, information about the result of the examination of the actual conditions, the result of the examination of the causes and the result of the investigation of the measures are reliably transmitted to a next division or manager, and furthermore, the execution of the measures and the effects of the measures are to be reported as information to each division or each manager.

However, the information have conventionally been transferred and reported by a paper document. Therefore, there have been a problem that the document is lost in the middle, progress is grasped with difficulty and a division or manager carrying out the work with a delay cannot be guided thoroughly. Therefore, a system for preventing the recurrence of the process failure is insufficient.

Moreover, the type of a process failure, the frequency of occurrence thereof and the cause thereof are useful technical information. These information can be useful for update of manufacturing equipment, education and training for workers, design change of a product and the like by summarization and analysis of the information.

As described above, however, the information about the process failure has conventionally been kept as a paper document. Thus, there has been a problem that a very long time is required for the summarization and analysis to be carried out by a manual work and the information cannot be sufficiently utilized as technical information.

### SUMMARY OF THE INVENTION

Therefore, it is an object of the present invention to provide a process failure information management system in which information about a process failure can be reliably transmitted to each division or manager and a division or manager which takes measures with a delay can be guided reliability.

Moreover, it is another object of the present invention to provide a process failure information management system in which a series of works including the occurrence of a process failure, the execution of the measures and the confirmation of the effects can be managed as a report and can be utilized as technical information through retrieval and reading.

Furthermore, it is a further object of the present invention to provide a process failure information management system which can easily totalize and analyze information about a process failure and can be utilized for preventing the recurrence of the process failure.

The present invention provides a process failure information management system including a server and a terminal connected through a network. A user inputs information about a process failure by using the terminal and the input information is stored in a database of the server. When a certain user inputs the information about the process failure and the information input by the user is stored in the database, the server transmits an electronic mail for requesting input of information to a user who carries out input at a next step.

Moreover, the present invention provides a process failure information management system including a server and a terminal connected through a network. A user inputs information about a process failure by using the terminal and the input information is stored in a database of the server. The information about the process failure and the date of the input by the user is stored in the database. When the next user does not carry out the input even if a predetermined period passes from the date of the input stored in the database, the server transmits an electronic mail to urge the input of the information to the user to carry out the input at the next step.

Moreover, the present invention provides a process failure information management system including a server and a terminal connected through a network. A user inputs information about a process failure by using the terminal and the input information is stored in a database of the server. Information to be input is assigned to a plurality of input steps and a notification destination for giving a notice by an electronic mail at the time of end of at least any of the plurality input steps is stored in the database.

Moreover, the present invention provides a process failure information management system including registration and input means for storing input information about a process failure in a database, term managing means for carrying out a reminder through mail means when next input is not performed even if a predetermined time passes after the input, retrieving and reading means for retrieving and reading the information stored in the database, totalizing means for totalizing the information stored in the database, and output means for outputting the information stored in the database as a paper document in a predetermined format.

According to the present invention, it is possible to reliably give a request for executing investigations and measures to each manager at a proper time. Consequently, the recurrent prevention measures against the process failure can be taken reliably.

In the procedure, for preventing the process failure recurrence, from the execution of investigations and measures to the confirmation of the measures and the effect, moreover, the current situations of progress can be grasped and the procedure can be wholly carried out reliably by performing a guidance.

According to the present invention, furthermore, the input by the user can be easily carried out so that the burden of the user can be relieved. In the use of the process failure management system, accordingly, the resistance feeling of the user can be reduced and a transition from the conventional management of a paper document can be carried out easily and smoothly.

According to the present invention, it is possible to totalize and analyze the tendency and transition of process failure occurrence from various viewpoints. Furthermore, the report in the form of paper document is created from the information stored and managed in the database. Therefore, the information can be managed unitarily and time taken for newly creating the paper document is not required, and furthermore, input errors are not made during the creation of the paper document.

### BRIEF DESCRIPTION OF THE DRAWINGS

FIG. 1 is a view illustrating the basic structure of a process failure information management system according to the present invention;

FIG. 2 is a diagram schematically showing the function of a server in the process failure information management system according to the present invention;

FIG. 3 is a flow chart showing the operation of the process failure information management system according to the present invention;

FIG. 4 is a diagram showing an example of a new registration screen in the process failure information management system according to the present invention;

FIG. 5 is a diagram showing an example of a primary investigation result input screen in the process failure information management system according to the present invention;

FIG. 6 is a diagram showing an example of a secondary investigation result input screen in the process failure information management system according to the present invention;

FIG. 7 is a diagram showing an example of a measure input screen in the process failure information management system according to the present invention;

FIG. 8 is a diagram showing an example of a measure confirmation result input screen in the process failure information management system according to the present invention;

FIG. 9 is a diagram showing an example of an effect confirmation result input screen in the process failure information management system according to the present invention;

FIG. 10 is a diagram showing an example of a reading display screen in the process failure information management system according to the present invention;

FIG. 11 is a diagram showing an example of a modification input screen in the process failure information management system according to the present invention;

FIG. 12 is a diagram showing an example of a report retrieval screen in the process failure information management system according to the present invention;

FIG. 13 is a diagram showing an example of a retrieval result list display screen in the process failure information management system according to the present invention;

FIG. 14 is a diagram showing an example of the retrieval result list display screen in the process failure information management system according to the present invention;

FIG. 15 is a diagram showing an example of an analysis result display screen in the process failure information management system according to the present invention;

FIG. 16 is a diagram showing an example of a news mail in the process failure information management system according to the present invention;

FIG. 17 is a diagram showing an example of a measure completion report mail in the process failure information management system according to the present invention;

FIG. 18 is a diagram showing an example of a reminder mail in the process failure information management system according to the present invention;

FIG. 19 is a diagram showing an example of the table of a database in the process failure information management system according to the present invention;

FIG. 20 is a diagram showing an example of the table of the database in the process failure information management system according to the present invention;

FIG. 21 is a diagram showing an example of the master of the database in the process failure information management system according to the present invention;

FIG. 22 is a diagram showing an example of the master of the database in the process failure information management system according to the present invention; and

FIG. 23 is a diagram showing an example of a report to be a paper document in the process failure information management system according to the present invention.

### DETAILED DESCRIPTION

Preferred embodiments of the present invention will be described below with reference to the accompanying drawings.

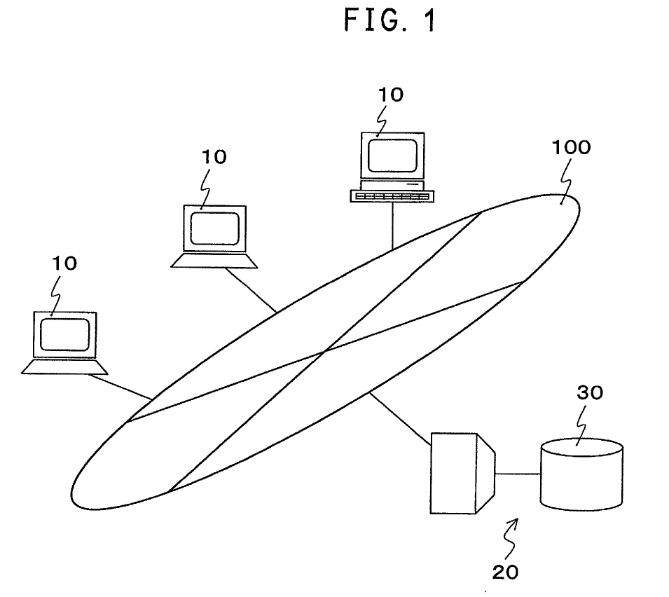

A process failure information management system, according to the present invention premises, as an infrastructure, a network environment using an intranet shown in FIG. 1. More specifically, the process failure information management system according to the present invention comprises at least one server 20 and a plurality of terminals 10, both of which can be connected through a network 100. The server 20 has a function of an intranet server and a database 30. Each terminal 10 can utilize a service provided by the server 20 through a Web browser.

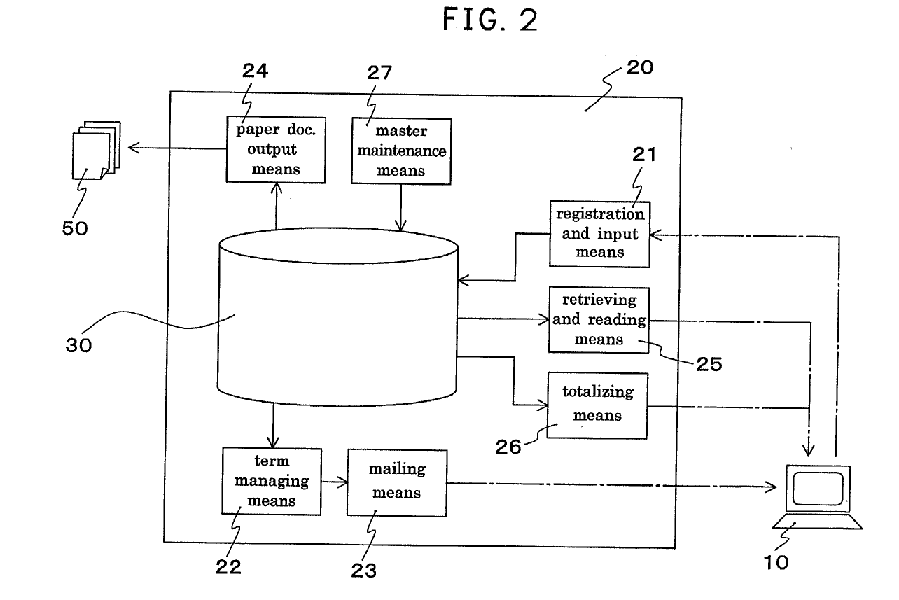

The function of the server 20 will be schematically described with reference to FIG. 2.

As shown in FIG. 2, the server 20 comprises registration and input means 21, term managing means 22, mailing means 23, paper document output means 24, retrieving and reading means 25, totalizing means 26 and master maintenance means 27, and furthermore, comprises a database 30 as described above.

The registration and input means 21 first registers information about a process failure input from the terminal 10 to the database 30, and adds and stores additional information in the database 30 when information about the process failure is additionally input from the terminal 10. Moreover, the registration and input means 21 gives a notice of the registration or addition of information as a news report and gives a request for executing a work to a designated division or manager by utilizing the mailing means 23. The term managing means 22 retrieves the database 30 to ascertain whether or not each division or manager carries out a work within a predetermined term. If the work has not been executed, a demand mail is transmitted by using the mailing means 23. The paper document output means 24 sets the information about the process failure in the database 30 into a predetermined form and outputs the same information as a paper document 50. The retrieving and reading means 25 retrieves the information in the database 30 and transmits and displays the same information to the terminal 10 in response to a request sent from the terminal 10. The totalizing means 26 totalizes the information stored in the database 30 and transmits and displays the totalized information to the terminal 10. The master maintenance means 27 carries out maintenance such as addition or modification for each master stored in the database 30.

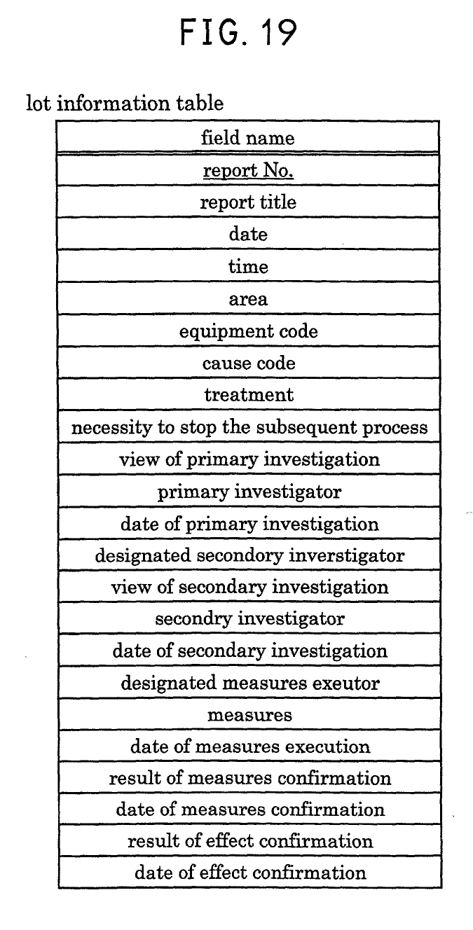

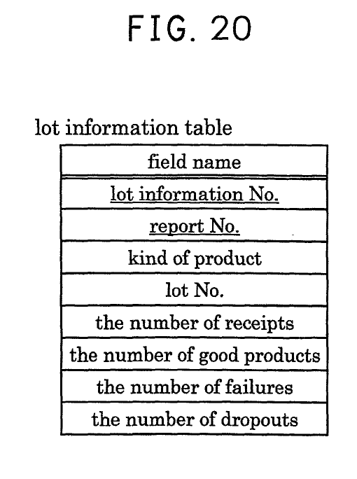

An example of the structure of the database 30 will be described with reference to FIGS. 19 and 20. In this example, the database 30 includes a report table and a lot information table.

As shown in FIG. 19, the report table stores a report title representing the type of the report, a date when a process failure occurs, an area and an equipment in which the process failure occurs and the cause of the process failure by setting, as a key, a report number uniquely provided to each process failure. Moreover, the report table stores treatment for the product and the results of investigations carried out after the process failure, the executed measure, the result of effect confirmation of the measures and the like. Furthermore, investigation and measure executors and an execution date are also stored. In the drawing, the name of a field to be the key is underlined.

As shown in FIG. 20, the lot information table stores a kind name, a lot number, the number of failures and dropouts caused by a process failure by setting, as a key, a lot information number uniquely provided to each lot information. Moreover, a report number is stored as a foreign key.

### Embodiment 1

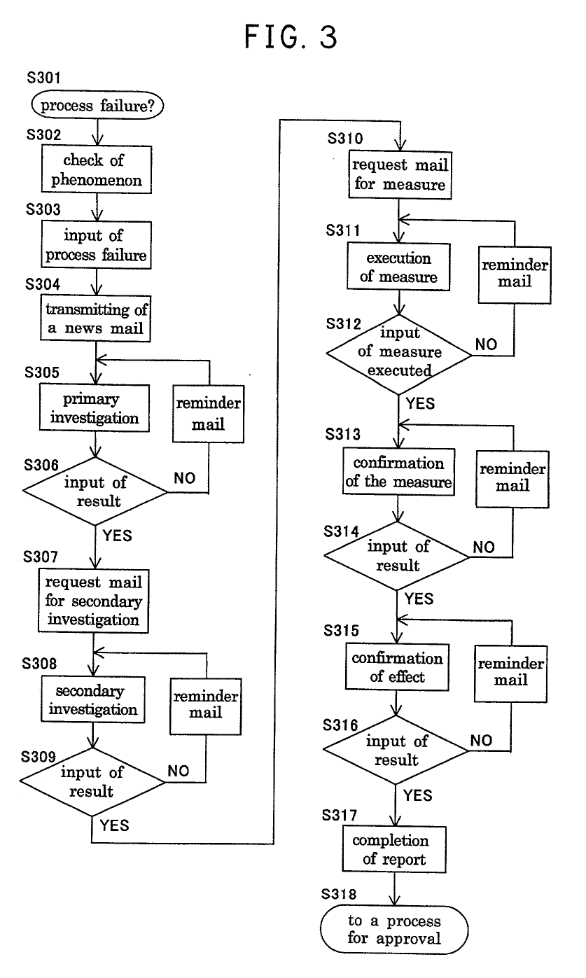

The operation of a process failure information management system according to the present invention will be described by using a flow chart in FIG. 3.

In the case where such a phenomenon as to be supposed as a process failure is caused in any of manufacturing processes (step S301), the technical staff in a manufacturing department first checks the phenomenon (step S302). As a result, if it is decided that the process failure is caused, the occurrence of the process failure is input to the process failure information management system according to the present invention (step S303).

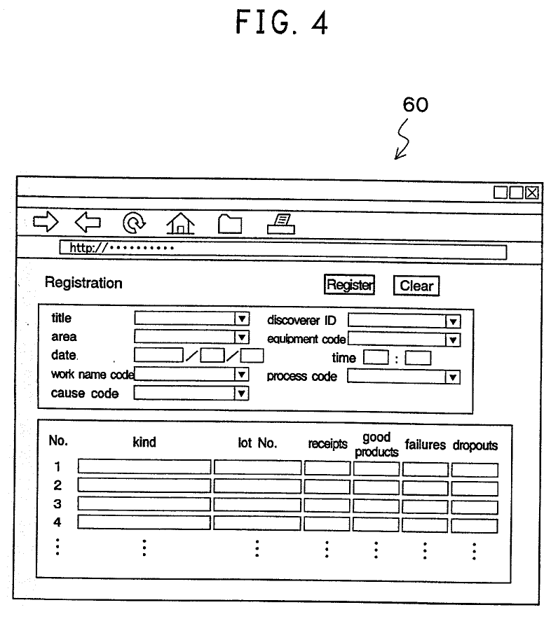

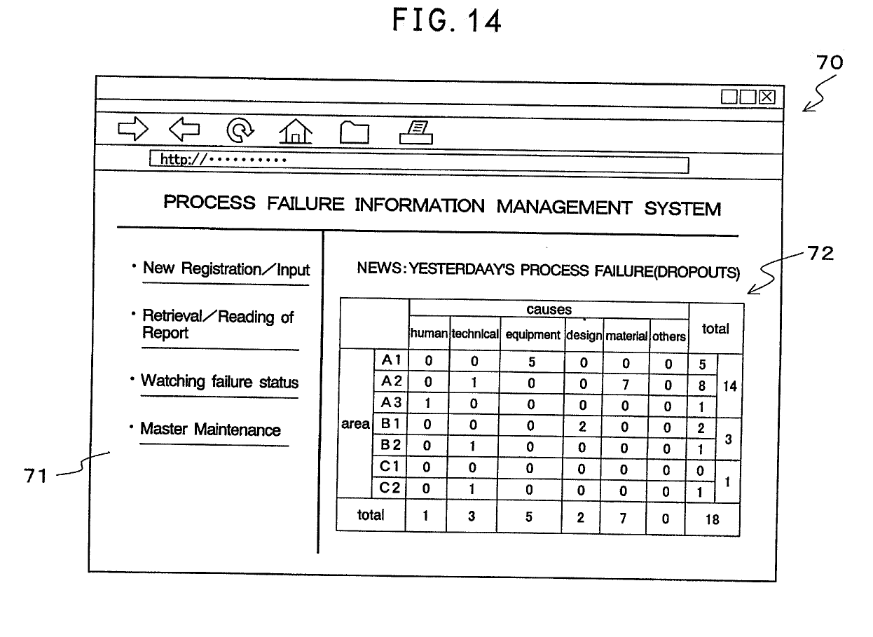

The input is carried out through a network 100 by using a terminal 10. First of all, when a user (the technical staff in the manufacturing department) accesses a server 20 by using the terminal 10, an initial screen 70 shown in FIG. 14 is transmitted from the server 20 and is displayed on the display screen of the terminal 10. Next, when the user selects “New Registration/Input” from the displayed menu 70, a screen 60 for new registration shown in FIG. 4 is transmitted from registration and input means 21 of the server 20 and is displayed on the display screen of the terminal 10.

In each input item in the new registration screen 60, a report title represents the type of a process failure. For example, in the case where all products in one lot cannot be used due to the process failure, “lot-out” is input by selection from a pull-down menu. If some in one lot cannot be used, “drop-out” is input by the selection from the pull-down menu. If the process failure is slight but the cause thereof is to be studied and care is to be taken in subsequent processes, “process failure” is input by the selection from the pull-down menu.

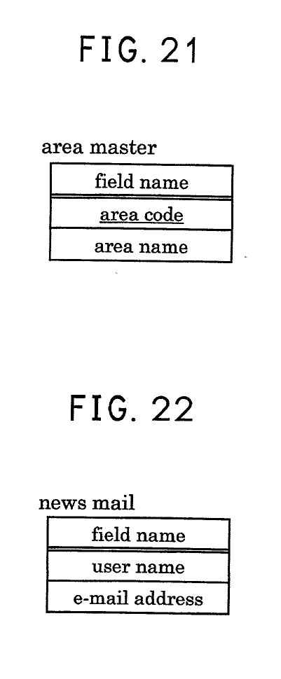

Moreover, an ID of a user who found the process failure is input to a discoverer ID by selection from the pull-down menu, and an area and an equipment in which the process failure occurs are input to an area and an equipment code by the selection from the pull-down menu. Furthermore, the date and time that the process failure occurs are input by key-in of the user or selection from the pull-down menu. By the selection from the pull-down menu, moreover, a work and a process in which the process failure is caused are input to a work name code and a process code and the cause of the process failure is input to a cause code. For the selection from the pull-down menu, various masters are stored in the database 30. For example, as shown in FIG. 21, an area master, in which an area name and an area code corresponding to each area name are stored, is prepared for inputting the area of the process failure.

Furthermore, a lot number and a kind of product in a lot in which the process failure occurs are input together with the number of receipts, the number of good products, the number of failures and the number of dropouts for each lot. As described above, the number of dropouts represents the number of products which cannot be used (that is, which are discarded) in each lot, and the number of failures represents the number of products which are to be carefully treated in subsequent processes and can still be used (does not need to be discarded).

When the user inputs these input items and clicks a “register” button, the input information is transmitted to the server 20. The registration and input means 21 of the server 20 assigns a report number peculiar to the received information and stores the same information as a new record in the report table of the database 30. Moreover, a peculiar lot information number is assigned and stored in the lot information table together with the kind name, the lot number, the number of dropouts and the number of failures.

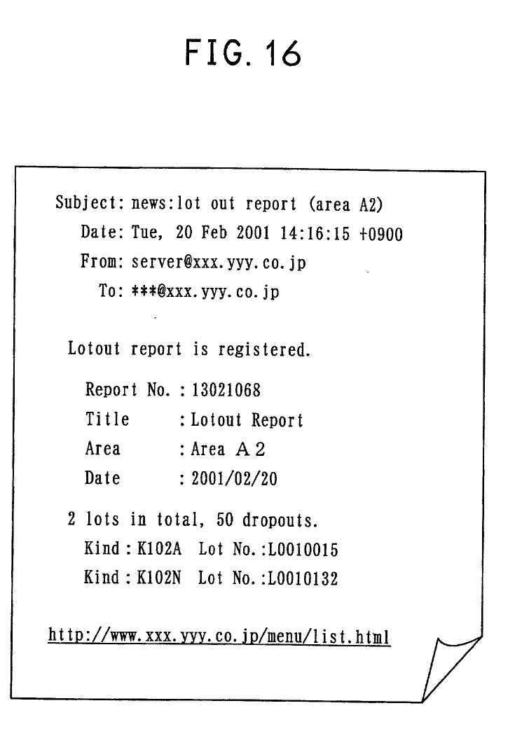

Simultaneously with the storage in the database 30, the mailing means 23 of the server 20 transmits a news mail for reporting the occurrence of the process failure to the user stored in the news mail user master (step S304). FIG. 16 shows an example of the news mail. In order to transmit such a mail, the news mail user master shown in FIG. 22 is prepared for the database 30 and stores a user name and a mail address for a transmission destination of the news mail.

Subsequently, a manager for a primary investigation is determined and the primary investigation is carried out (step S305). The manager for the primary investigation finally decides as to the treatment of each lot, that is, as to whether a lot is set to “lot-out” or some products in the lot are set to “dropouts” or “process failure”, and furthermore, decides whether or not a subsequent process is to be stopped. The decision carried out by a primary investigation manager is input to the process failure information management system (step S306).

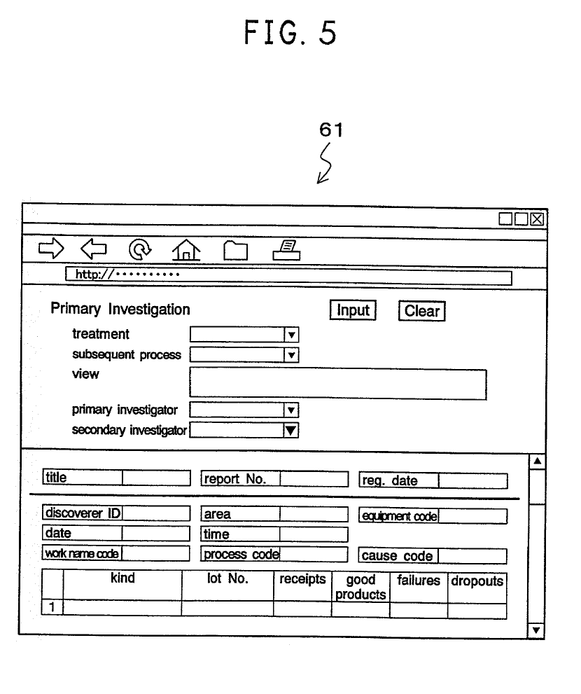

The input is carried out through the network 100 by using the terminal 10. A primary investigation result input screen 61 shown in FIG. 5 is transmitted from the registration and input means 21 of the server 20 and is displayed on the display screen of the terminal 10. A user (that is, a primary investigator) uses the primary investigation result input screen 61 and inputs the treatment of each lot, the necessity for stopping a subsequent process and a simple view. Furthermore, the user inputs his (her) own user ID as the primary investigator, determines a manager for a secondary investigation and inputs his/her user ID. At this time, it is preferable that the treatment of each lot, the necessity for stopping a subsequent process, the user ID of the primary investigator and the user ID of the secondary investigator are input by selection from the pull-down menu.

When the user inputs these input items and clicks an “input” button, the input information is transmitted to the server 20. The registration and input means 21 of the server 20 receives the information and stores the received information additionally to the report table of the database 30. More specifically, the information are stored in each of fields including a treatment code, a subsequent process stop decision, a view on a primary investigation, a primary investigator and a secondary investigator in the record of the corresponding report number. Moreover, the mailing means 23 of the server 20 transmits a mail for requesting the execution of the secondary investigation to the user specified as the manager for the second investigation (step S307).

The user who receives a request for the secondary investigation carries out further investigations and studies of the cause of the process failure (step S308) and inputs them as a final view to the process failure information management system (step S309).

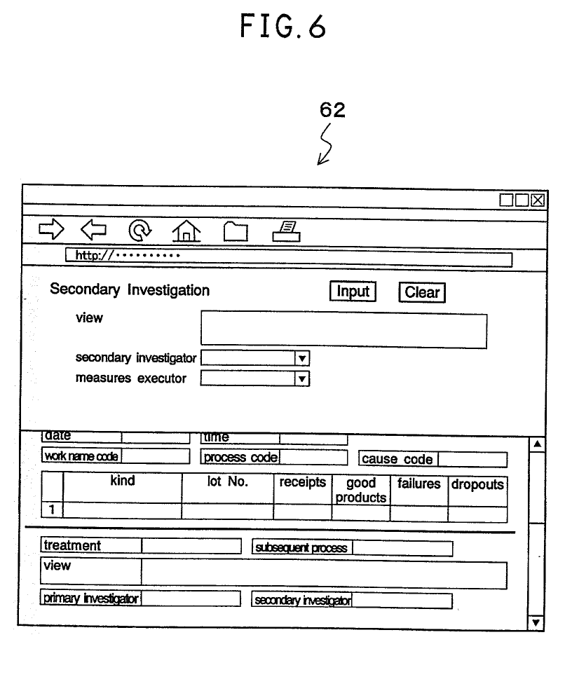

The input is carried out through the network 100 by using the terminal 10. A secondary investigation result input screen 62 shown in FIG. 6 is transmitted from the registration and input means 21 of the server 20 and is displayed on the display screen of the terminal 10. The user (that is, a secondary investigator) inputs a final view by using the secondary investigation result input screen 62. Furthermore, the user inputs his (her) own user ID as the secondary investigator, determines a manager who executes measures to prevent recurrence of the process failure, and inputs his/her user ID. At this time, it is preferable that the user ID of the secondary investigator and the user ID of the measure executor are input by the selection from the pull-down menu.

When the user inputs these input items and clicks the “input” button, the input information is transmitted to the server 20. The registration and input means 21 of the server 20 additionally stores the received information to the report table of the database 30. Moreover, the mailing means 23 of the server 20 transmits a mail for requesting the execution of the recurrence prevention measures to the user specified as the measure executor (step S310).

The user who receives the request to execute measures drafts the recurrence prevention measures with reference to the view of the secondary investigator or the like. For the measures against the recurrence, it is possible to suppose the repair of equipment having drawbacks, the execution of education for an operator and the like. The user who receives a request for the execution of the measures takes these measures (step S311) and inputs the contents of the measures thus taken and an execution date to the process failure information management system (step S312).

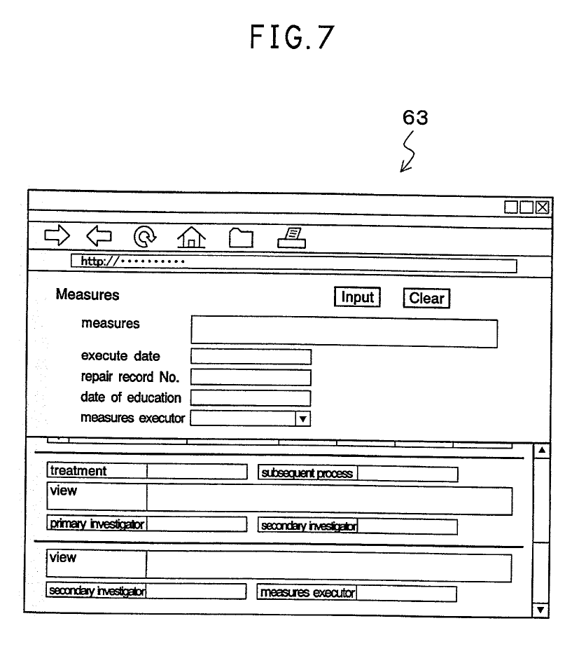

The input is carried out through the network 100 by using the terminal 10. A measure input screen 63 shown in FIG. 7 is transmitted from the registration and input means 21 of the server 20 and is displayed on the display screen of the terminal 10. The user (that is, the measure executor) inputs the contents of the measures thus executed and an execution date by using the measure input screen 63 and inputs his (her) own user ID as a measure executor. Furthermore, in the case where the equipment is repaired, it is preferable that the number of repair record is input. If the operator is educated, it is preferable that the date of education is input. At this time, it is preferable that the user ID of the measure executor is input by selection from the pull-down menu.

When the user inputs these input items and clicks the “input” button, the information thus input is transmitted to the server 20. The registration and input means 21 of the server 20 additionally stores the received information to the report table of the database 30.

Subsequently, the measure executor confirms that the measures are executed as intended or not (step S313), and inputs a measure confirmation result to the process failure information management system (step S314). For example, in the case where the equipment is repaired, it is confirmed that the equipment is operated normally after the repair and a comment indicative thereof is input. Moreover, in the case where the operator is educated, it is confirmed that the work is carried out according to the education and a comment indicative thereof is input.

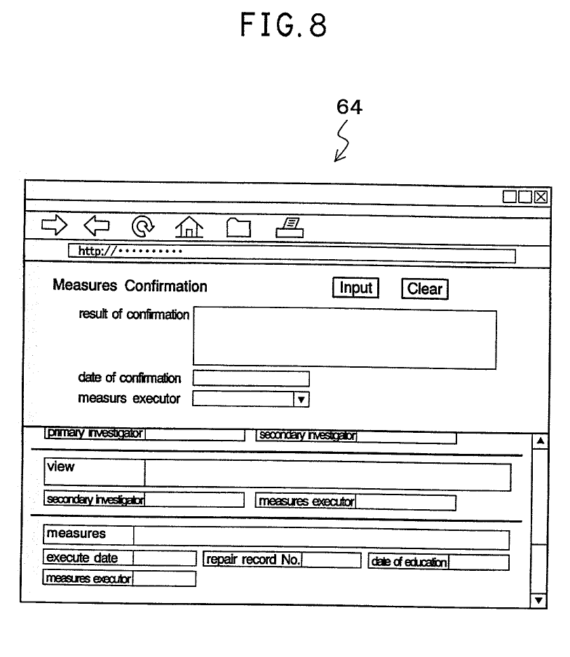

The input is carried out through the network 100 by using the terminal 10. A measure confirmation result input screen 64 shown in FIG. 8 is transmitted from the registration and input means 21 of the server 20 and is displayed on the display screen of the terminal 10. The user uses the measure confirmation result input screen 64 to input the result of the measure confirmation and the execution date of the measure confirmation and to input his (her) own user ID as a measure confirmer. At this time, it is preferable that the user ID of the measure confirmer is input by selection from the pull-down menu.

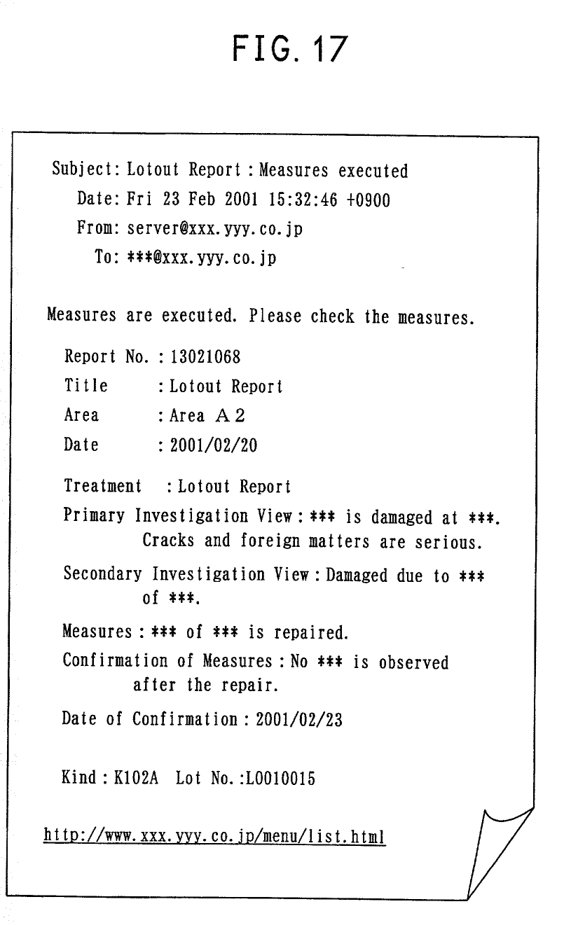

When the user inputs these input items and clicks the “input” button, the information thus input is transmitted to the server 20. The registration and input means 21 of the server 20 additionally stores the received information to the report table of the database 30. Moreover, it is desirable that the completion of the measures and the contents of the measures are transmitted to a manager or technical staff in a manufacturing process. Therefore, the mailing means 23 of the server 20 transmits a measure completion report mail for reporting the completion of the measures and the contents of the measures to the user stored in the measure completion report user master. FIG. 17 shows an example of the measure completion report mail.

Furthermore, the measure executor confirms the effect of the measures (step S315) and inputs an effect confirmation result to the process failure information management system (step S316). For example, it is confirmed that the same kind of process failures are not caused for several days or over several weeks after the execution of the measures, and a comment indicative thereof is input.

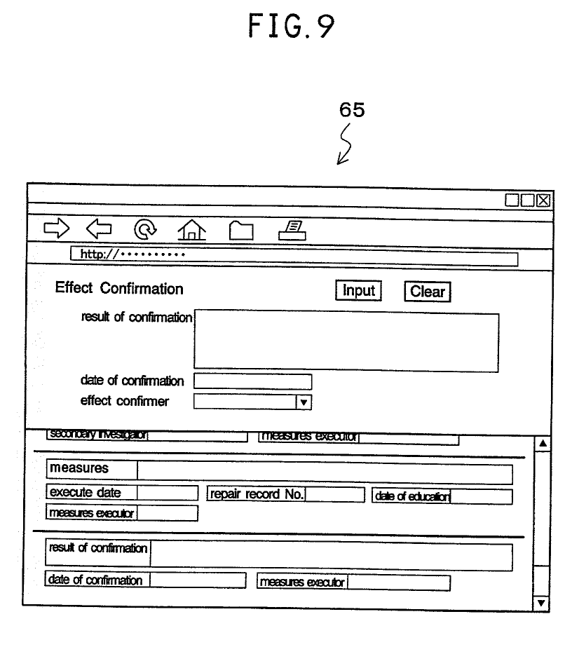

The input is carried out through the network 100 by using the terminal 10. An effect confirmation result input screen 65 shown in FIG. 9 is transmitted from the registration and input means 21 of the server 20 and is displayed on the display screen of the terminal 10. The user uses the effect confirmation result input screen 65 to input the confirmation result of the effect and the execution date of the effect confirmation and to input a user ID of an effect confirmer himself (herself). At this time, it is preferable that the user ID of the effect confirmer is input by selection from the pull-down menu.

When the user inputs these input items and clicks the “input” button, the information thus input is transmitted to the server 20. The registration and input means 21 of the server 20 additionally stores the received information to the report table of the database 30.

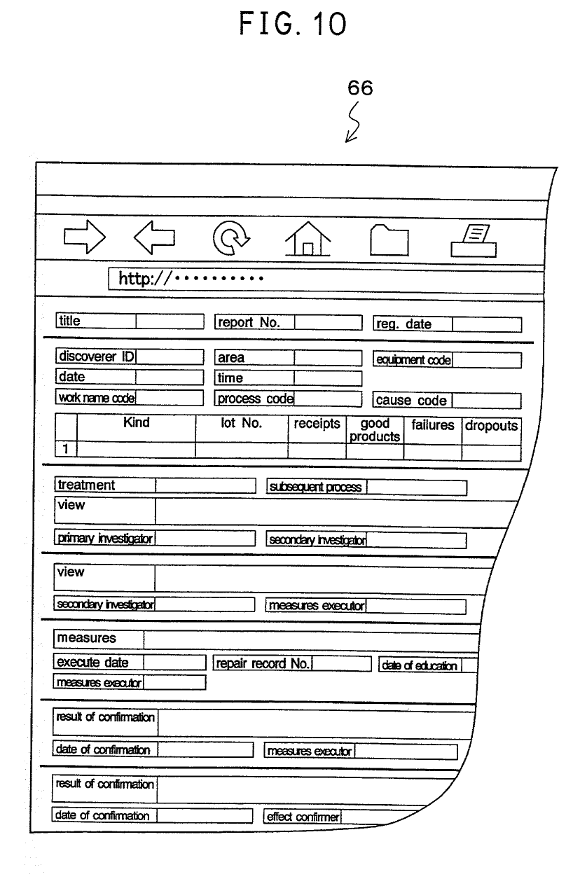

As described above, the occurrence of a process failure and the conditions thereof, the treatments for a lot subjected to the process failure, the result of investigations of the cause, the contents of the measures and the confirmation of the execution, and the confirmation result of the effect of the measures are input to the database 30, and are completed and stored as a process failure report (step S317). The process failure report stored in the database 30 can be read from a reading display screen 66 on the terminal 10 shown in FIG. 10 through the network 100. If necessary, a process for acquiring authorization (step S318) might be provided after the completion of the process failure report, thereby acquiring the authorization of an administrator.

According to the present invention, when the occurrence of the process failure is first input, a request for investigations is transmitted by a mail to a manager. When the manager who receives the request carries out the investigation and inputs the result, a mail for requesting an execution of further investigation or measures is transmitted to a next manager. Accordingly, the execution of the investigation and the measures can be reliably requested to each manager at a proper time so that the recurrence prevention measures for the process failure can be taken reliably.

While a previous manager specifies a next manager in the above description, managers might be predetermined and stored in the database for the kind of the process failure, the area in which the process failure occurs or the work in which the process failure occurs. In the present embodiment, in the case where one user is to carry out one step, the sequential transmission of information is promoted and maintained between users and the execution of the investigation and the measures are taken over. For example, a user can also execute a plurality of steps by preparing the procedure for specifying a person himself (herself) as a user to carry out a next step.

### Embodiment 2

In Embodiment 1, preferably, the input screen for the user, that is, the primary investigation result input screen 61 in FIG. 5, the secondary investigation result input screen 62 in FIG. 6, the measure input screen 63 in FIG. 7, the measure confirmation result input screen 64 in FIG. 8 and the effect confirmation result input screen 65 in FIG. 9 are divided into two parts, i.e. upper and lower portions, as shown in the drawings respectively, and items to be newly input and input windows to input the items are displayed on the upper portion and the information already input is displayed on the lower portion.

For example, in the primary investigation result input screen 61 shown in FIG. 5, it is preferable that the input windows for the treatment of each lot, the necessity for stopping a subsequent step, the view of a primary investigation, and the user IDs of the primary investigator and the secondary investigator, which are to be input using the screen 61, are provided in the upper portion and the report title, the ID of the discoverer, the date and time of occurrence and the like, which have already been input, are displayed on the lower portion.

In the secondary investigation result input screen 62 shown in FIG. 6, similarly, it is preferable that the input windows for the view of the secondary investigation, and the user IDs of the secondary investigator and the measure executor, which are to be input using the screen 62, are provided in the upper portion and the treatment of each lot, the necessity for stopping a subsequent step, the view of the primary investigation, the primary investigator and the secondary investigator, which are input using the primary investigation result input screen 61, as well as the report title, the discoverer ID and the date and time of occurrence are displayed on the lower portion.

Thus, the items to be input in each input screen are displayed on the upper portion and the input item is displayed on the lower portion. Consequently, the items to be input can be clearly shown for the user and an input omission and an input to wrong items can be prevented. Moreover, the input can be carried out by referring to the input item, that is, the situation of a process failure, the result of investigations which have been executed and the like. Therefore, the contents to be input can easily be investigated and input. As described in Embodiment 1, furthermore, most of the input items in each input screen are provided in a pull-down menu. Accordingly, the input can easily be carried out and the input error can be prevented.

### Embodiment 3

In the present embodiment, in the case where the result of a secondary investigation, the execution of measures, the confirmation of the measures and the result of effect confirmation are not input even if a predetermined term passes after the primary investigation, secondary investigation or the measures are executed, a guidance is carried out through a mail.

As described above, the report table of the database 30 is provided with the field for storing the execution date of the primary investigation, the execution date of the secondary investigation (accurately, the date that the results of the primary investigation or the secondary investigation is input), the execution date of the measures and the execution date of the measure confirmation, and furthermore, a field for storing the secondary investigator and the executor of the measures. Furthermore, the staff master stores the name and mail address of a manager to execute the investigations and the measures.

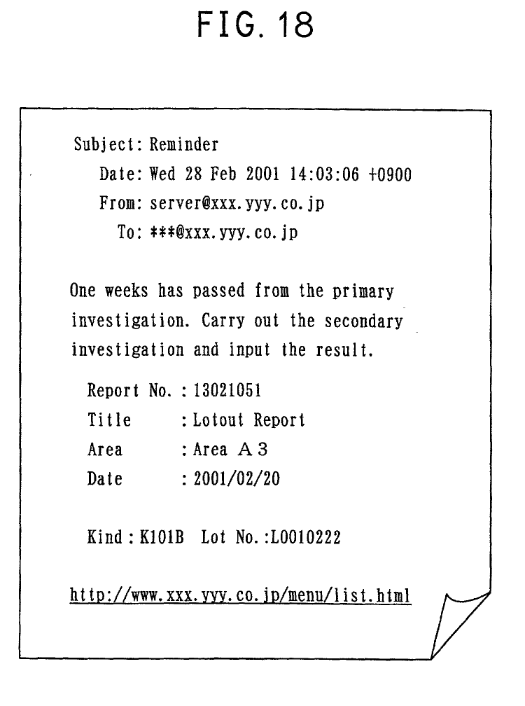

The term managing means 22 of the server 20 refers to the report table of the database 30 and extracts a record in which the result of the secondary investigation has not been input irrespective of the passage of a predetermined number of days from the execution date of the primary investigation, for example. In the extracted record, the secondary investigator is specified and input by the primary investigator. Therefore, the mailing means 23 finds the mail address of the secondary investigator with reference to a staff master and transmits a reminder mail for requesting to execute the secondary investigation and to input the result. An example of the reminder mail is shown in FIG. 18.

As shown in the flow chart of FIG. 3, similarly, in the case where the result of the primary investigation is not input, the case where the execution of the measures is not input, the case where the measure confirmation result is not input and the case where the effect confirmation result is not input after a predetermined number of days pass, the manager of the primary investigation or the manager of the measure execution is guided through a mail.

As descried above, in the present embodiment, a manager which takes measures with a delay is specified and a reminder mail is transmitted to carry out a guidance by referring to the report table in the database 30. Accordingly, it is possible to grasp the situations of current progress and to reliably execute all procedure in the procedure for preventing the recurrence of a process failure from the execution of the investigations and the measures to the confirmation of the measures and effects.

### Embodiment 4

As described in the Embodiment 1, a series of input results, by the respective managers, from the occurrence of the process failure to the effect confirmation of the measures are stored as a report for the process failure in a database 30. Accordingly, it is possible to retrieve the conditions of each process failure and measures thereagainst from various viewpoints.

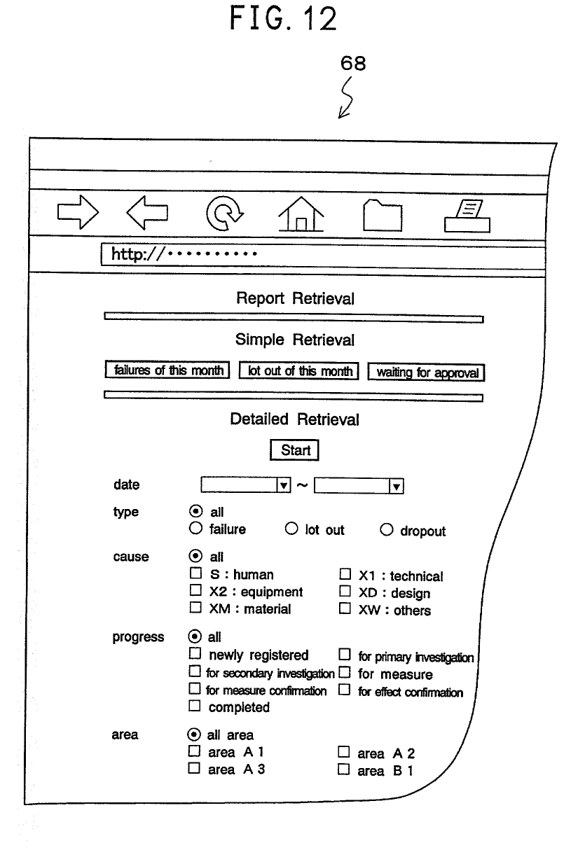

When the user selects “Retrieval/Reading of Report” from a menu display 71 of an initial screen 70 shown in FIG. 14, a report retrieval screen 68 shown in FIG. 12 is displayed on a terminal 10 of the user by the retrieving and reading means 25 of the server 20 . When the user specifies retrieval keys in the report retrieval screen 68, retrieving and reading means 25 retrieves the database 30, extracts a process failure coincident with the retrieval keys and causes the terminal 10 to display the process failure.

The retrieval is roughly divided into simple retrieval and detailed retrieval. In the simple retrieval, the retrieval which is used comparatively often is prepared as a button and a user can carry out the retrieval by clicking the button. In the example of FIG. 12, there are prepared a “this month whole list” button for displaying all process failures of this month, a “this month lot-out” button for displaying all process failures to be lot-out in this month and an “authorization waiting” button for displaying all process failure reports waiting for the authorization by an administrator. In the detailed retrieval, the user can specify the retrieval keys in more detail. In the example of FIG. 12, it is possible to specify a date on which the process failure occurs and a type of the process failure, the cause of the process failure and an area in which the process failure occurs, and the situations of progress of investigations and measures.

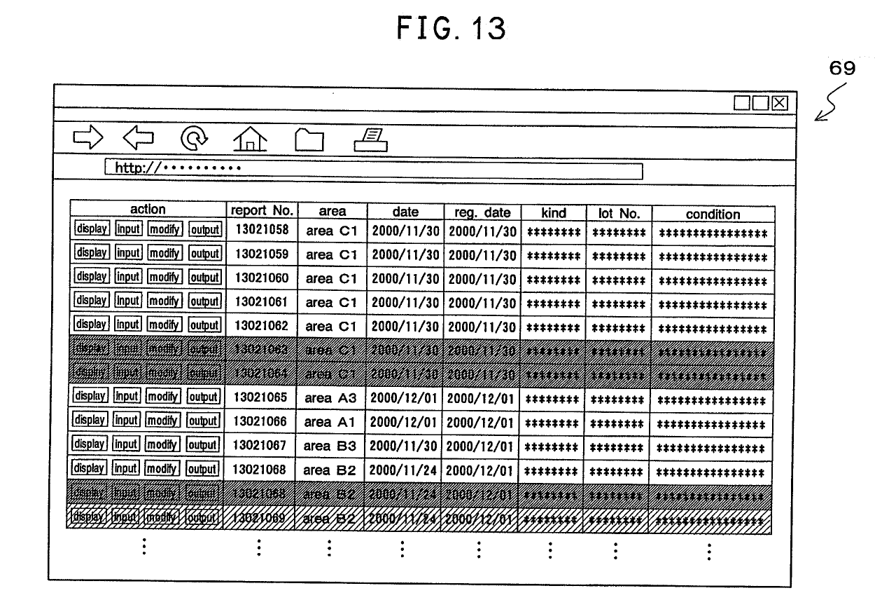

The result of the retrieval is displayed on the terminal 10 of the user in the retrieval result list display screen 69 shown in FIG. 13, for example. In the list display screen, a serious process failure such as lot-out is emphasized by making the background red (which is represented in fine hatching in FIG. 13), for example. Moreover, a process failure of middle degree such as the dropout of some products in a lot is emphasized by making the background green (which is represented in coarse hatching in FIG. 13), for example. By the emphasis display, the serious process failure can be prevented from being oversight even when browsing the screen.

Moreover, the retrieval result list display screen 69 shown in FIG. 13 is provided with “display”, “input”, “modify” and “output” buttons. When the user clicks the “display” button, a corresponding process failure is displayed on the terminal of the user in the reading display screen 66 of FIG. 10 through the retrieving and reading means 25.

When the user clicks the “input” button, any of the input screens shown in FIGS. 5 to 9 is displayed on the terminal 10 of the user by the registration and input means 21. For example, in the case where the input of the primary investigation result is completed, the secondary investigation result input screen in FIG. 6 is displayed by clicking the “input” button. In the case where the input of the secondary investigation result is completed, the measure input screen in FIG. 7 is displayed. Thus, the user can call the input screens in FIGS. 5 to 9 from the retrieval result list display screen and can input the investigation result, the measure execution, the results of measure confirmation or effect confirmation.

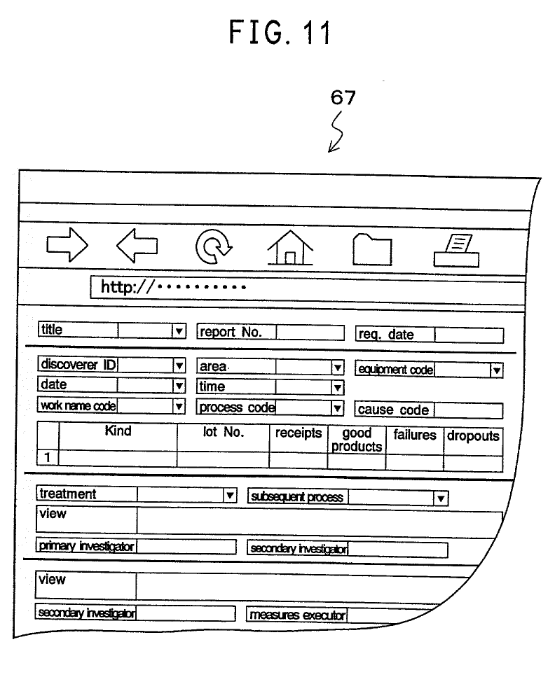

When the user clicks the “modify” button, the modification input screen 67 shown in FIG. 11 is displayed on the terminal 10 of the user by the registration and input means 21. The user can modify the input items by using the modification input screen 67. Also in the modification input screen, it is preferable that a pull-down menu is utilized for the input as much as possible to easily carry out the input of the user and to prevent input errors.

When the user clicks the “output” button, a paper document 50 is output by paper document output means 24. The output of the paper document will be described in Embodiment 6.

### Embodiment 5

As described above, the database 30 stores a series of input results, by respective managers, from the occurrence of a process failure to the measure effect confirmation as a report for the process failure. Accordingly, the totalizing means 26 of the server 20 can analyze and totalizes the contents of the process failure, that is, each field item of the database 30 from various viewpoints.

For example, the number of dropouts caused on the previous day can be totalized from the occurrence date field in the report table and the number of dropouts field in the lot information table. Furthermore, the number of dropouts can be totalized for each area or each cause from an area code or a cause code in the report table. The results of the totalization can be collected in a table or the like and, for example, can be utilized as a news information 72 of the process failure on the previous day on the initial screen 70 in FIG. 14, for example.

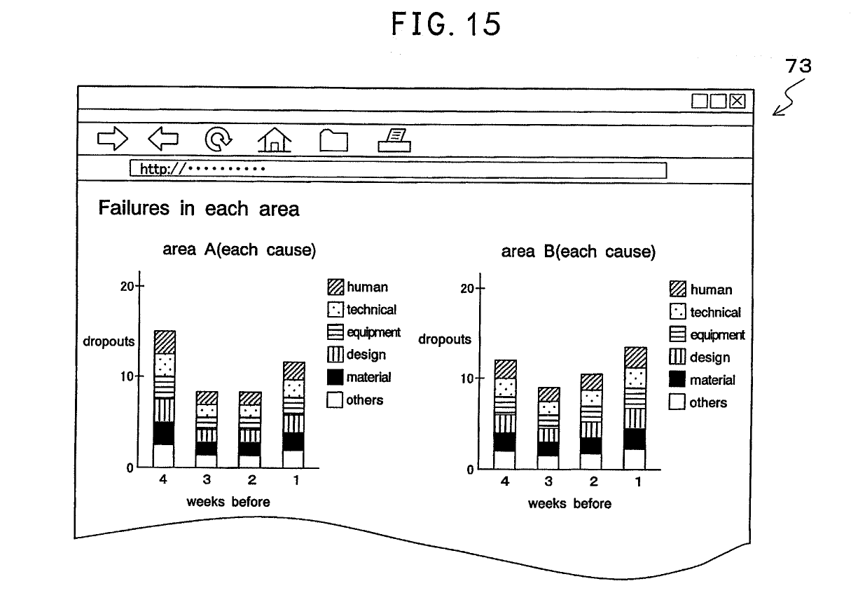

As shown in the analysis result display screen 73 of FIG. 15, moreover, it is also possible to totalize the number of dropouts in each area for each cause in a week and to utilize the same results in order to grasp the tendency and transition of the process failure in each area.

### Embodiment 6

As described above, the database 30 stores a series of input results, by the respective managers, from the occurrence of a process failure to the effect confirmation of measures as a report for the process failure. In the present embodiment, these are output as a report in the form of a paper document by a request sent from a user.

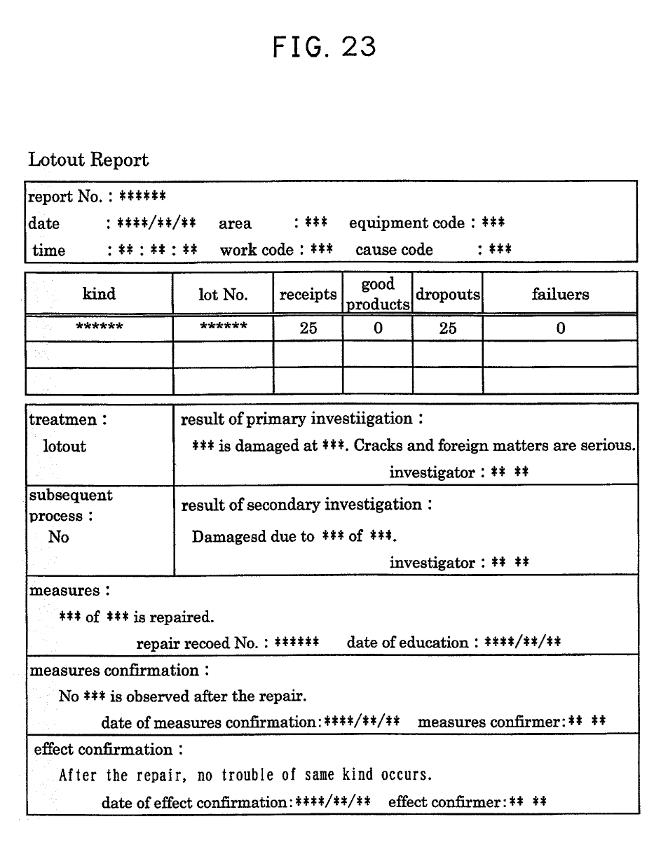

As described above in Embodiment 4, the retrieval result list display screen 69 in FIG. 13 is provided with an “output” button. When the user clicks the “output” button, a paper document 50 is output by paper document output means 24. The format of the paper document is predetermined and the paper document output means 24 reads the contents stored in the database 30 and outputs the same contents as a paper document in the predetermined format. An example of the report in the form of the paper document is shown in FIG. 23.

According to the present embodiment, the report in the form of paper document is created from the information stored and managed in the database 30. Therefore, the information can be unitarily managed and time taken for newly creating the paper document is not required, and furthermore, input errors are not made during the creation of the paper document.

What is claimed is:

1. A process failure information management system comprising a server and a terminal, in which an user inputs information concerning a process failure using the terminal and the input information are stored into a database of the server,
wherein in the case where information concerning a process failure is input by an user and stored into the database, the server sends an E-mail for asking for an input of information to an user who inputs information at the following step.

2. A process failure information management system comprising a server and a terminal, in which an user inputs information concerning a process failure using the terminal and the input information are stored into a database of the server,
wherein information concerning a process failure is input by an user and the date of input by the user is stored into the database, and in the case where a prescribed term has passed from the date of input stored in the database without input by an user of the following step, the server sends an E-mail for asking for an input of information to the user who inputs information at the following step.

3. The process failure information management system of claim 1, wherein the user inputting the information designates an user who inputs information at the following step, and the designation is stored into the database together with the input information.

4. The process failure information management system of claim 1, wherein an user who inputs information at each step is previously designated and the designations are stored in the database.

5. The process failure information management system of claim 1, wherein items of information to be input by the user who inputs information at the following step and the information input by the previous user are simultaneously but distinctively displayed on a screen of the terminal.

6. The process failure information management system of claim 1, wherein the database stores a master in which contents of information to be input by an user and code corresponding to the contents are described, and
wherein the server shows the contents to the user as choices on a screen of the terminal, and the code corresponding to the content chosen by the user is stored into the database as the information concerning the process failure.

7. The process failure information management system of claim 1, wherein the information concerning the process failure is input using a Web browser installed in the terminal.

8. The process failure information management system of claim 1, wherein the input information concerning the process failure is retrievable and readable from a Web browser installed in the terminal.

9. A process failure information management system comprising a server and a terminal, in which an user inputs information concerning a process failure using the terminal and the input information are stored into a database of the server,
wherein information to be input are assigned to a plurality of input steps, and for at least one of the input steps, destination to which E-mail notification is sent upon completion of the input step is stored in the database.

10. The process failure information management system of claim 1, further comprising an output means for outputting the input information concerning the process failure as a paper document.

11. A process failure information management system comprising,
a registration and input means for storing input information concerning a process failure into a database,
a term managing means for sending a reminder mail by using a mailing means when a predetermined period from the input has passed without the following input,
a retrieving and reading means for retrieving and reading of the information stored in the database,
a totalizing means for totalizing the information stored in the database, and
an output means for outputting the information stored in the database as a paper document of a predetermined format.
